(19) United States
(12) Patent Application Publication
(10) Pub. No.: US 2008/0100501 A1
(43) Pub. Date: May 1, 2008

(54) Antenna for a radar level gauge

(76) Inventor: Olov Edvardsson, Linkoping (SE)

Correspondence Address: WESTMAN CHAMPLIN & KELLY, P.A., SUITE 1400, 900 SECOND AVENUE SOUTH, MINNEAPOLIS, MN, 55402-3319, US

(21) Appl. No.: 11/586,877

(22) Filed: Oct. 26, 2006

(51) Int. Cl. G01S 13/08

(52) U.S. Cl. 342/124

(57) ABSTRACT

An antenna for a radar-based level gauge useable for determining a filling level of a filling material contained in a container is disclosed. The antenna comprises a reflector, which is symmetric around a symmetry axis; and a feeder for feeding microwave signals to and from the reflector. The feeder is of an elongate, essentially cylindrical shape, with a longitudinal axis of said feeder essentially coinciding with said symmetry axis of the reflector, wherein said feeder comprises a ring-shaped radiation feeding area for transmitting electromagnetic radiation towards the reflector and for receiving reflected electromagnetic radiation. In a preferred embodiment, an abutment ring is arranged around the feeder, wherein at least one of the feeder and the abutment ring are movable in relation to each other in the axial direction of said feeder, whereby simple and effective cleaning of the feeder is rendered possible. A method for cleaning an antenna is also disclosed.

### FIELD OF THE INVENTION

The present invention relates to a antenna for a radar-based level gauge for determining the filling level of a filling material in a tank, as well as a method of cleaning such an antenna.

### BACKGROUND OF THE INVENTION

Radar level gauging (RLG) to measure the level of a filling material, such as a liquid or a solid like a granulate is an increasingly important method for level gauging in tanks, containers, etc. During the years, a multitude of different antennas have been proposed for use in various RLG systems, such as horn, parabolic, planar and rod antennas. In order to create narrow antenna beams symmetric parabolas, arrays and to a certain extent horns have been used so far for radar level gauging. For example, a rod antenna for use in RLG is disclosed in U.S. Pat. No. 6,859,166, a parabolic antenna for RLG is disclosed in US 2006/0005621 and an array antenna for RLG is disclosed in U.S. Pat. No. 6,759,977.

However, an underlying problem when seeking to find an appropriate antenna for radar level gauging is that general purpose antennas are basically not designed to meet the special level gauging problems. In RLG systems, the antennas are subject to severe risk of contamination, e.g. by the filling material to be contained in the container, condensation, etc. In level gauging applications, antennas therefore need to have a good ability to withstand contamination from e.g. the filling material, splashing and condensation, e.g. by, as far as possible, being free of hidden spaces and the like, where contamination may assemble. In contrast to most general radar antennas, the radar beam in level gauging is close to vertical, and many standard type antennas may, by such a mounting, accumulate condensation and contaminations, especially on nearly horizontal surfaces. Due to the special microwave properties of water, even one or a few tenths of a mm of wet dirt may have a disastrous influence of the antenna function and performance. In particular it is important to avoid contamination of the sensitive parts of the antennas. Narrow spaces where surface tension can keep liquid in a sensitive area is one typical problem and contamination on an insulation surface where the radar beam must pass is another.

A first goal when designing antennas for RLG use is therefore to avoid contamination. However, since it is not always possible to avoid contamination, at least after a prolonged use, a second goal is to provide means for as safe and easy cleaning of the antenna as possible. For example, it would be preferred if such cleaning of the antenna could be made without opening the tank, since the tank may be pressurized or filled by some poisonous substance.

Further, the space available for the antennas is often limited, both within the tank and in the tank opening. Horn antennas are commonly used for radar level gauge systems, but since these antennas tend to become rather large and voluminous if a large diameter is required, they may be unsuitable for many types of applications and tank geometries. Further, the trend has recently been to use shorter wavelengths in RLG systems, which makes horn antennas a less practical antenna alternative, e.g. due to tiny spaces present at the tip and since longer horns are required at a specified diameter.

Planar antennas, such as array antennas, are normally relatively much affected by contamination, and is difficult to use in harsh in-tank environments. Further, it is normally difficult to obtain leakage free installations of array antennas. Still further, array antennas are normally relatively expensive.

Parabolic antennas are normally relatively easy and inexpensive to produce, and are relatively reliable during operation. Parabolas are more suited for big diameters than horns, and can, as compared to arrays, be made mainly of durable materials, such as stainless steel, etc. However, parabolic antennas are also relatively much affected by contaminations, and are difficult to use under harsh operating conditions. In such environments, which is commonly present in e.g. marine use, cleaning of the antenna is frequently needed, and often as frequently as once or several times a month. The cleaning operation is normally manual, and can e.g. be performed with a brush through an openable hatch in the container roof. Needless to say, this cleaning process is both cumbersome and expensive. Further, the parabola antenna in a typical tank installation will give some hidden space, e.g. above the parabola, where tank content may accumulate.

Another potential need for antennas in radar level gauging systems is to adjust the direction of the radar beam to match the need for a vertical radar beam to be emitted towards the filling material, which may be difficult in practice, depending on the specific container design. For example, the flanges on which the antenna is to be mounted may be non-horizontal.

Thus, there is still a need for an improved antenna for radar-based level gauging that could alleviate the above-discussed problems. Specifically, there is a need for an antenna that is usable in harsh environmental conditions, and which is less prone to be contaminated and/or which is easier to clean.

### SUMMARY OF THE INVENTION

It is therefore an object of the present invention to provide an antenna for a radar-based level gauge useable for determining a filling level of a filling material, as well as a method for cleaning such an antenna, which at least partly alleviate the above-discussed problems of the prior art.

This object is achieved with the antenna and the method according to the appended claims.

According to a first aspect of the invention, there is provided an antenna for a radar-based level gauge useable for determining a filling level of a filling material contained in a container, wherein said antenna comprises: a reflector, which is arranged around an axis; and a feeder for feeding microwave signals to and from the reflector, wherein said feeder is of an elongate, essentially cylindrical shape, with a longitudinal axis of said feeder essentially coinciding with said axis of the reflector, and wherein said feeder comprises a ring-shaped radiation feeding area for transmitting electromagnetic radiation towards the reflector and for receiving reflected electromagnetic radiation.

The ring-shaped radiation feeding area may be a continuous area covered by radiation element, but may also be an area, covered to a certain extent by radiation elements spread out in the radiation feeding area. The actual radiation elements within said ring shaped area may take many various forms and shapes, such as longitudinal or circumferential slots, but will be contained within a ring-shaped area on the cylindrical surface of the feeder. Further, the ring-shaped area need not necessarily be arranged at the same height of the feeder, but e.g. spiral shapes etc. would also be feasible.

The cylindrical shape of the feeder is preferably circular cylindrical, but other cylindrical shapes are also feasible.

This antenna combines the inherent advantages of previous parabolic antennas, such as robustness, reliability and compactness, as well as the provision of narrow antenna beams, with a significantly improved resistance against contamination and enablement of easier and more efficient cleaning methods.

The new geometry for the antenna solves the most difficult limitations for antennas presently used for radar level gauging. The basic geometry allows several practical realizations, all aiming at being less prone to contamination and/or allowing simple antenna cleaning, and also preferably allowing lobe alignment with limited mechanical movements.

The present inventor has realized that the disturbance caused by contaminations is much higher on the feeder than on the reflector. Accordingly, the most important part to keep clean and free from contaminations is the radiation feeding area on the feeder. Here, the feeder is of an elongate, essentially cylindrical shape, with a longitudinal axis of said feeder essentially coinciding with said axis of the reflector, which is normally in the vertical direction. The feeder comprises a ring-shaped radiation feeding area for transmitting electromagnetic radiation towards the reflector and for receiving reflected electromagnetic radiation. This geometry makes the feeder less prone to be contaminated on the radiation feeder area, since the outer area of the feeder is less exposed to contamination from below, and since contaminations, such as condensation, is less prone to stick on the vertical surface. Further, this geometry relatively simple, with absence of hidden spaces and the like, which are likely to be contaminated.

Further, the simple geometry of the present antenna makes maintenance and service of the antenna simpler, such as replacement of the feeder in an existing antenna. By its basic cylindrical geometry, the feeder can be attached in such a way that it can be moved upwards, without moving the parabola, for mounting and replacement.

Still further, the vertical cylindrical shape of the feeder makes it possible to clean the feeder in a more simple fashion, and even to perform the cleaning operation from outside the container, by simple mechanical movement either by pulling up the cylinder, without necessarily opening the tank, or by having a ring, such as a short hollow cylinder, movable along the cylinder. Thus an efficient cleaning function can be accomplished without opening the tank and if necessary under pressure.

The ring-shaped radiation feeding area is preferably arranged to transmit and receive radiation in a direction essentially radially to and from the longitudinal axis of said feeder, and preferably the radiation pattern from said feeder is essentially doughnut-shaped. Hereby, a narrow and well directed radiation beam may be provided towards the filling material by reflection in the reflector. The reflector is parabolic-like, but is preferably shaped with regard to the doughnut-like pattern from the feeder, in order to optimize the vertical antenna beam.

The cylindrical feeder preferably has a circular cross-section with an essentially constant diameter over the length of the feeder.

The reflector can be of many different shapes and dimensions. For example, generally parabolic or generally conical shapes are feasible. Preferably, at least the outer part of the reflector, i.e. the part of the reflector which is farthest away from said feeder, is essentially conical. Further, it is preferred that the conical part of the reflector has an inclination of about 45 degrees in relation to the feeder. Various reflector diameters can be used to the same feeder. The shape of the reflector is preferably basically a cone, but preferably has its shape optimized by a finite element software. Preferably, an outer perimeter of the reflector is connected to walls of the container, whereby hidden spaces above the reflector can be avoided. The reflector is preferably arranged symmetrically around the reflector axis, and around the feeder.

The ring-shaped radiation feeding area is preferably arranged at a height which is lower than the longitudinal extension of the reflector, in the direction of the axis of the reflector and seen from the base of the reflector.

In a preferred embodiment, the antenna further comprises an abutment ring arranged around the feeder, wherein at least one of the feeder and the abutment ring are movable in relation to each other in the axial direction of said feeder. Hereby, the feeder can be cleaned by scraping off contaminations on the feeder by said relative displacement. In one line of embodiment, the abutment ring is displaceable along the feeder, and wherein the antenna further comprises means for remotely positioning the abutment ring from outside the container. For example, the means for remotely positioning the abutment ring can comprise one or several guide lever(s). Alternatively, the abutment ring may be connected to the reflector, wherein the feeder is axially displaceable in relation to the abutment ring and the reflector.

Alternatively or in addition, the feeder is preferably movable in a radial or lateral direction in relation to the reflector for adjustment of a radiation pattern for the antenna, such as adjustment of the antenna lobe. Hereby, the direction of the emitted radiation, i.e. the lobe direction, may be adjusted after installation of the antenna, which is advantageous when e.g. the mounting flanges are non-horizontal etc. It is also possible to move the whole antenna, including the feeder. To this end, the feeder or the whole antenna can be mounted on an adjustable ball joint, but also simpler mechanic solution where both reflector and feeder are slightly asymmetric and possible to rotate during the mounting to give a limited inclination of the antenna beam are feasible. A conventional box seal is another way to allow a sealed adjustment by simple means.

The cylindrical feeder preferably has a diameter within the range 5-50 mm, and most preferably within the range 10-20 mm. It is also preferred that the feeder diameter corresponds to at least a half wavelength of the electromagnetic radiation for which the antenna is used.

According to another aspect of the invention there is provided a radar level gauge for determining the filling level of a filling material in a tank, comprising an antenna as discussed above. The radar level gauge preferably comprises: a transmitter for transmitting measuring signals towards the surface of the filling material; a receiver for receiving echo signals from the tank; and processing circuitry for determining the filling level of the tank based on said echo signals received by said receiver. Further, the antenna is preferably arranged in an upper part of said tank, and arranged to transmit electromagnetic radiation in an essentially vertical direction. Still further, the feeder of the antenna is preferably arranged essentially vertically within the tank.

According to still another aspect of the invention there is provided a method for cleaning an antenna for a radar-based level gauge useable for determining a filling level of a filling material contained in a container, wherein said method comprises:

providing a reflector;

providing a feeder for feeding microwave signals to and from the reflector, wherein said feeder is of an elongate, essentially cylindrical shape;

providing an abutment ring arranged around the feeder; and

displacing at least one of the feeder and the abutment ring in relation to each other in the axial direction of said feeder, thereby scraping off dirt from the feeder surface.

In accordance with this aspect, similar advantages and preferred features are obtainable as have already been discussed with respect to the first aspect.

These and other aspects of the invention will be apparent from and elicited with reference to the embodiments described hereinafter.

### BRIEF DESCRIPTION OF THE DRAWINGS

For exemplifying purposes, the invention will be described in closer detail in the following with reference to embodiments thereof illustrated in the attached drawings, wherein:

FIG. 1 is a schematic cross-sectional side view of a container, in which an antenna device according to the embodiment is arranged;

FIG. 2 is a cross-sectional side view of an antenna device according to one embodiment of the present invention;

FIG. 3 is a cross-sectional side view of an antenna device according to a second embodiment of the present invention;

FIG. 4 is a cross-sectional side view of an antenna device according to a third embodiment of the present invention;

FIG. 5 is a cross-sectional side view of an antenna device according to a fourth embodiment of the present invention;

FIG. 6 is a cross-sectional side view of an antenna device according to a fifth embodiment of the present invention; and

FIG. 7 is a cross-sectional side view of an antenna device according to a sixth embodiment of the present invention.

### DESCRIPTION OF PREFERRED EMBODIMENTS

FIG. 1 shows schematically a radar level gauge system 2, incorporating an antenna according to the present invention. In brief, the system in FIG. 1 comprises an electronic unit 3 for transmitting and receiving radar signals and processing the received signals in order to determine the level 8 of a filling material in the tank 1, an antenna 4 arranged inside the tank for transmitting and receiving radar waves into the tank, to be discussed in more detail in the following, and a radar wave guide assembly 5 for guiding signals between the electronic unit 3 and the antenna 4. The same antenna could preferably be used both as a transmitter for emitting the output radiation and as a receiver for receiving the reflected echo signal, even though it is also possible to use separate antennas for these functions. The radar level gauge is preferably arranged on the tank roof 7, whereby the waveguide 5 is arrange to protrude into the tank through a tank opening 6.

In use, the radar level gauge 2 transmits radar energy along the waveguide 5 through the tank roof port and receives reflected energy from the liquid surface 8 to provide an indication of the level of the liquid within the tank. The radar level gauge 2 could be coupled to a remote location (for example a control room) via a signal wire or the like.

The system may use pulsed or continuously emitted radiation. In case pulsed signals are used, the signals can be DC pulses with a length of about 2 ns or less, with a frequency in the order of MHz, at average power levels in the nW or μW area. Alternatively, the pulses are modulated on a carrier wave of a GHz frequency. If required, the tank is provided with a sealing, arranged to allow the electromagnetic signals to pass through the wall of the tank while maintaining an air tight seal, so as to prevent tank contents from escaping from the tank.

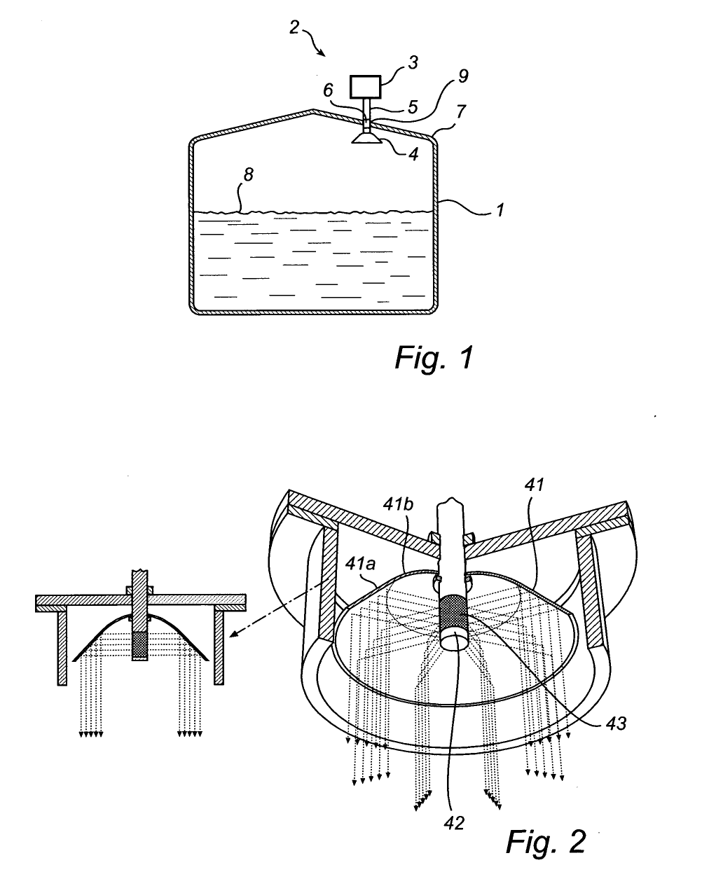

A first embodiment of the antenna 4 is illustrated in FIG. 2. The antenna comprises a reflector 41 and a feeder 42 for feeding microwave signals to and from the reflector. The reflector 41 is symmetric around a symmetry axis, but may take different shapes and dimensions. However, in a preferred embodiment, the reflector comprises a generally conical outer part 41a, i.e. the part being most remote from the feeder, and a generally parabolic inner part 41b. i.e. the part being closest to the feeder. The essentially conical part of the reflector preferably has an inclination of about 45 degrees in relation to the feeder. The exact shape and dimensions of the reflector may be optimized for certain feeder and application conditions, e.g. by using a finite element software.

The feeder 42 is of an elongate, essentially cylindrical shape, with a longitudinal axis of said feeder essentially coinciding with said symmetry axis of the reflector, which is normally in the vertical direction, i.e. perpendicular to the surface of the filling material.

The cylindrical feeder preferably has a circular cross-section with an essentially constant diameter over the length of the feeder.

The cylindrical feeder preferably has a diameter within the range 5-50 mm, and most preferably within the range 10-20 mm. The feeder can e.g. be made of steel.

The feeder comprises a ring-shaped radiation feeding area 43 for transmitting electromagnetic radiation towards the reflector and for receiving reflected electromagnetic radiation. The ring-shaped radiation feeding area is preferably arranged at a height which is lower than the axial extension of the reflector, in the direction of the symmetry axis and seen from the base of the reflector, i.e. the reflector extends deeper into the container than the feeder, or at least the part of the feeder carrying the radiation feeding area 43. The radiation feeding area is preferably arranged to transmit and receive radiation in a direction essentially radially to and from said feeder, and preferably the antenna pattern from said feeder is essentially doughnut-shaped out from the feeder, as is schematically illustrated in FIG. 2, whereby a narrow and well directed beam is provided by the reflector towards the filling material surface.

Thus, the feeder presents a relatively smooth and even cylindrical outer surface towards the interior of the container. The radiation feeding area 43 and the waveguide 5 for guiding electromagnetic signals between the electronic unit 3 and the radiation feeding area 43 may be realized in many different ways, as would be appreciated by someone skilled in the art. For example, the radiation feeding area 43 may be realized as a ring-shaped cylindrically curved array antenna, which may be connected to electronic unit 3 by ordinary electric signal wires (not shown). Radiating half-wave slots which are arranged vertically (along the cylinder), horizontally (circumferentially) or inclined 45°, are likely candidates, which can be made as holes in a steel pipe or the like. However, the radiation feeding area 43 may also be realized as a window transparent to the radar signals, whereby the waveguide may be a wave guide tube or the like. Other realization alternatives are however also feasible.

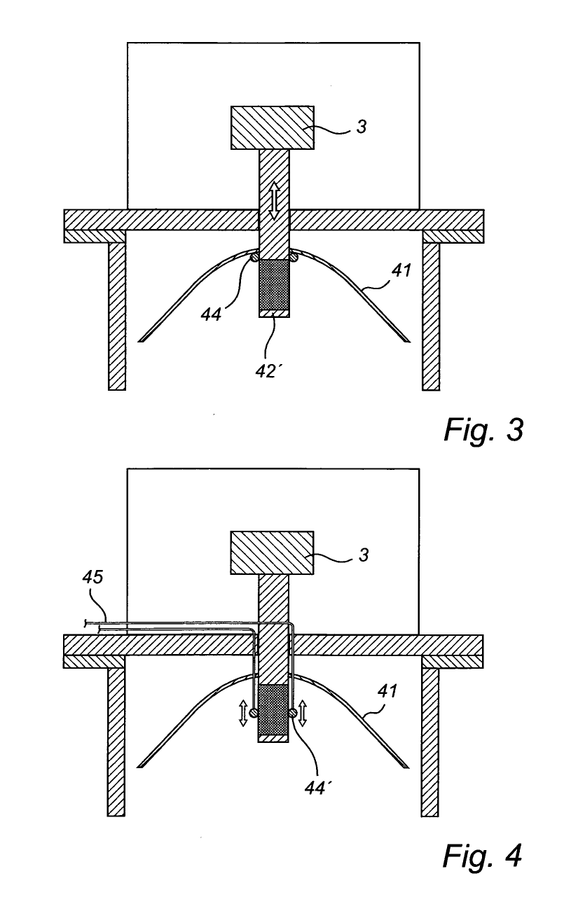

The shape of the feeder provides vertical radiation feeding surfaces, which are less sensitive for contamination. However, another advantage of the above-discussed feeder shape is that it can be cleaned by simple mechanical movement either by pulling up the cylinder, without necessarily opening the tank, or by moving a ring, such as a short cylinder, along the cylinder. Thus an efficient cleaning function can be accomplished without opening the tank, and may also, if necessary, be accomplished under pressure. Two embodiments involving such cleaning means will now be discussed in some more detail, with reference to FIGS. 3 and 4. It is to be appreciated by those skilled in the art, that features from the different embodiments may be combined in various ways.

In the embodiment illustrated in FIG. 3, the antenna further comprises an abutment ring 44 arranged around the feeder, and fixedly connected to the reflector 41. Further, the feeder 42′ is axially displaceable in relation to the abutment ring. Hereby, the feeder can be moved up and down in relation to the reflector and the abutment ring, thereby enabling cleaning of the feeder surface by scraping off contaminations on the feeder by said relative displacement. Preferably, the feeder is displaceable at least far enough for the radiation feeding area to pass the abutment ring. After the cleaning movement the residual tank content will then have fallen down into the tank or is attached to the lowest part of the feeder, below the radiation feeding area, which is not sensitive to the dirt. The abutment ring may be of a solid material or of a flexible material, such as rubber, and can either be integrated with the reflector or be provided as a separate part. Preferably, the abutment ring also functions as a seal, and may e.g. be embodied as an O-ring seal. Further, it is also feasible to use two or more abutment rings, arranged at different heights.

The feeder may in this embodiment be actuated from outside the tank, whereby the cleaning operation may be conducted without opening the tank, and without exposing the operator and the external parts to the tank content. Further, the entire displacement operation may be performed while e.g. maintaining a non-atmospheric pressure in the container.

Displacement of the feeder as is disclosed above may also be used for adjusting the radiated beam pattern, and may also be used for maintenance and service, such as for repair work or for replacement of the feeder.

In FIG. 4, an alternative embodiment for causing a relative movement between the feeder and the abutment ring is illustrated. In this embodiment, the abutment ring 44′ is displaceable relative to the feeder 42 and the reflector 41. Hereby, a similar cleaning operation as discussed above in relation to FIG. 3 is rendered possible. Preferably, the abutment ring 44′ is controllable from outside the container, by means of e.g. one or several guide lever(s) 45. The guide levers may be rigid or flexible, and in case flexible levers, such as wires, are used, they may be guided in guiding tubes or the like.

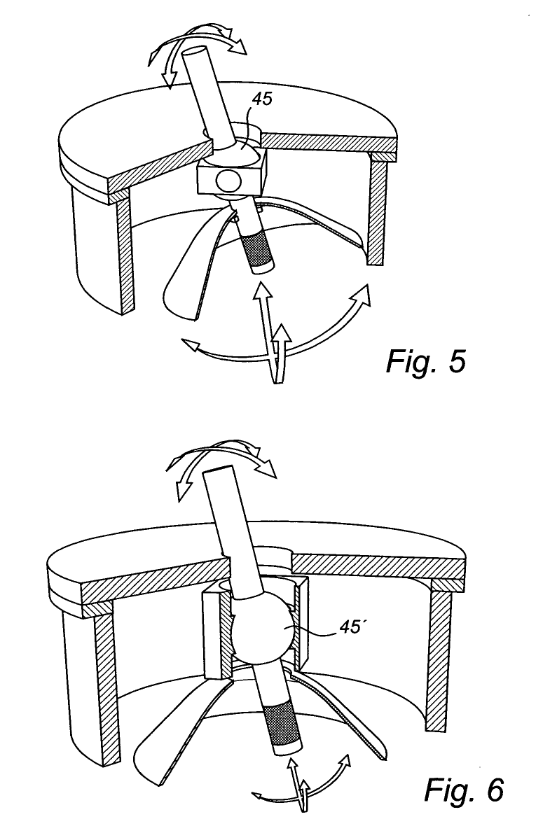

Alternatively or in addition, the feeder may also be movable in a radial or lateral direction in relation to the reflector for adjustment of the antenna lobe. Hereby, the direction of the emitted radiation, i.e. the lobe direction, may be adjusted after installation of the antenna. For adjustment of the lobe direction either the whole antenna or just the feeder cylinder can be adjustable. In FIG. 5, an embodiment is illustrated where the whole antenna, comprising the reflector 41 and the feeder 42, is connected to the tank opening through a ball joint 46, thereby enabling adjustment of the antenna angle in relation to the tank. In FIG. 6, an alternative arrangement is illustrated, in which the ball joint 46′ is arranged between the feeder and the reflector, whereby only the feeder is adjustable. However, several alternative means for radial or lateral adjustment of the antenna and/or the feeder are feasible, such as by making the reflector and feeder slightly asymmetric, whereby rotating can provide a limited inclination of the antenna beam. A conventional box seal is another way to allow a sealed adjustment by simple means. As the angular movements of the feeder are small, it is also possible to arrange a welded metal surface around the pivot point of the feeder to avoid contamination and hidden spaces, as an alternative to the ball joint discussed above. For instance, the feeder can be welded directly to the reflector if it is made of a rather thin material, or with suitable dents to make it locally flexible to allow for small angular movements of the feeder.

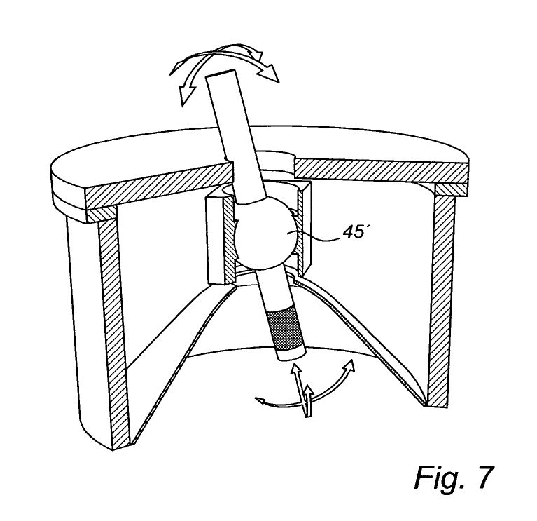

FIG. 7 illustrates a further embodiment, where the outer perimeter of the reflector is in contact with the opening walls of the tank. Hereby, the space above the reflector is sealed off relative to the tank interior, and is not exposed to the tank contents. Thus, hidden spaces behind the reflector is avoided. The reflector perimeter is preferably connected to the opening walls of the tank, e.g. by welding, by compression between flanges, or the like.

It is to be appreciated by those versed in the art that various combinations of the above-discussed embodiments and specific features of the disclosed antenna are possible.

Specific embodiments of the invention have now been described. However, several alternatives are possible, as would be apparent for someone skilled in the art. For example, the above-discussed antenna may be used in many different types of radar level gauging systems. Further, different shapes and dimensions of the reflector are feasible, the signal transmission through the feeder may be accomplished in various ways, relative movement between the feeder and the abutment ring may be enabled in different ways, etc. Such and other obvious modifications must be considered to be within the scope of the present invention, as it is defined by the appended claims.

1. An antenna for a radar-based level gauge useable for determining a filling level of a filling material contained in a container, wherein said antenna comprises:
a reflector, which is arranged around an axis; and
a feeder for feeding microwave signals to and from the reflector, wherein said feeder is of an elongate, essentially cylindrical shape, with a longitudinal axis of said feeder essentially coinciding with said axis of the reflector, and wherein said feeder comprises a ring-shaped radiation feeding area for transmitting electromagnetic radiation towards the reflector and for receiving reflected electromagnetic radiation.

2. The antenna of claim 1, wherein the ring-shaped radiation feeding area is arranged to transmit and receive radiation in a directions essentially radially to and from the longitudinal axis of said feeder.

3. The antenna of claim 1, wherein the radiation pattern from said feeder is essentially doughnut-shaped.

4. The antenna of claim 1, wherein the feeder has a circular cross-section with an essentially constant diameter over the length of the feeder.

5. The antenna of claim 1, wherein, in the direction of the symmetry axis and seen from a base of the reflector, the ring-shaped radiation feeding area is arranged at a height which is lower than the longitudinal extension of the reflector.

6. The antenna of claim 1, further comprising an abutment ring arranged around the feeder, wherein at least one of the feeder and the abutment ring are displaceable in relation to each other in the axial direction of said feeder.

7. The antenna of claim 6, wherein the abutment ring is displaceable along the feeder, and wherein the antenna further comprises means for remotely positioning the abutment ring from outside the container.

8. The antenna of claim 7, wherein the means for remotely positioning the abutment ring comprises at least one guide lever.

9. The antenna of claim 6, wherein the abutment ring is connected to the reflector, and wherein the feeder is axially displaceable in relation to the abutment ring and the reflector.

10. The antenna of claim 1, wherein the feeder is movable in at least one of a radial and lateral direction in relation to the reflector for adjustment of a radiation pattern for the antenna.

11. The antenna of claim 1, wherein the cylindrical feeder has a diameter within the range 5-50 mm.

12. The antenna of claim 11, wherein the cylindrical feeder has a diameter within the range 10-20 mm.

13. The antenna of claim 1, wherein at least the part of the reflector which is farthest away from said feeder is essentially conical.

14. The antenna of claim 13, wherein the conical part of the reflector has an inclination of about 45 degrees in relation to the feeder.

15. The antenna of claim 1, wherein an outer perimeter of the reflector is connected to walls of the container.

16. The antenna of claim 1, wherein the reflector is arranged symmetrically around said axis.

17. A radar level gauge for determining the filling level of a filling material in a tank, comprising an antenna according to claim 1.

18. The radar level gauge of claim 17, further comprising:
a transmitter for transmitting measuring signals towards the surface of the filling material;
a receiver for receiving echo signals from the tank; and
processing circuitry for determining the filling level of the tank based on said echo signals received by said receiver.

19. The radar level gauge of claim 17, wherein the antenna is arranged in an upper part of said tank, and arranged to transmit electromagnetic radiation in an essentially vertical direction.

20. The radar level gauge of claim 17, wherein the feeder of said antenna is arranged essentially vertically within said tank.

21. A method for cleaning an antenna for a radar-based level gauge useable for determining a filling level of a filling material contained in a container, wherein said method comprises:
providing a reflector;
providing a feeder for feeding microwave signals to and from the reflector, wherein said feeder is of an elongate, essentially cylindrical shape;
providing an abutment ring arranged around the feeder; and
displacing at least one of the feeder and the abutment ring in relation to each other in the axial direction of said feeder, thereby scraping off contamination from the feeder surface.

22. The method of claim 21, wherein the step of displacing involves displacing of the abutment ring along the feeder, wherein the abutment ring is remotely controlled from outside the container.

23. The method of claim 21, wherein the step of displacing involves displacing of the feeder in relation to the abutment ring and the reflector.

101-123. (canceled)
